(19) United States
(12) Patent Application Publication
(10) Pub. No.: US 2014/0373573 A1
(43) Pub. Date: Dec. 25, 2014

(54) APPARATUS AND METHOD FOR MANUFACTURING 3D GLASS

(71) Applicant: Samsung Display Co., Ltd., Yongin-City (KR)

(72) Inventors: Seong Jin Hwang, Suwon-si (KR); Jong Hwan Kim, Seoul (KR); Jin Seok Jang, Asan-si (KR); Kwan Young Han, Seongnam-si (KR); Hyoung Suk Roh, Cheonan-si (KR); Jae Seung Jeon, Cheonan-si (KR)

(73) Assignee: Samsung Display Co., Ltd., Yongin-City (KR)

(21) Appl. No.: 14/065,331

(22) Filed: Oct. 28, 2013

(30) Foreign Application Priority Data
Jun. 25, 2013 (KR) 10-2013-0072904

(51) Int. Cl. C03B 23/03; C03B 35/14

(52) U.S. Cl. CPC C03B 23/0302; C03B 35/14
USPC 65/104; 65/171; 65/157

(57) ABSTRACT

An apparatus for manufacturing 3D glass, the apparatus including: a molding part for molding a glass substrate; an assembling and disassembling part for carrying-out the molded glass substrate and replacing the molded glass substrate with an other glass substrate; and a loading part for loading the molded glass substrate is disclosed. A method for manufacturing 3D glass including: carrying-in a mold including a glass substrate into a chamber of a molding part; preheating the carried-in mold; molding the glass substrate by pressing the heated mold; cooling the molded glass substrate; and carrying-out the molded glass substrate and carrying-in an other glass substrate into the mold is also disclosed.

### CROSS-REFERENCE TO RELATED APPLICATION

This application claims priority to and the benefit of Korean Patent Application No. 10-2013-0072904 filed in the Korean Intellectual Property Office on Jun. 25, 2013, the entire contents of which are incorporated herein by reference.

### BACKGROUND

1. Field

Embodiments of the present invention relate to an apparatus and a method for manufacturing 3D glass.

2. Description of the Related Art

As a method for manufacturing a panel displaying images, such as a liquid crystal display of electronic products, a panel has been manufactured by performing injection molding of synthetic resins. For example, technologies of manufacturing a window by injection molding a transparent poly(methyl methacrylate) (PMMA) or polycarbonate (PC) resin and manufacturing a window product by performing UV hard coating and then performing a printing process have been conducted. The foregoing technologies provide methods which may configure products, such as 2.5D and 3D products, as well as simple products, such as flat type products, without much difficulty, by performing the injection molding process.

However, with the advent of touch type panels, tempered glass has been used in a panel for electronic products, instead of a synthetic resin. Unlike flat glass products formed by cutting large flat glass manufactured in a glass factory for each size, curved glass products are manufactured by thermally deforming the flat glass to form a curved shape. Therefore, curved glass products have a disadvantage in that they are difficult to manufacture, but they have an advantage in the form of an increase in the added value of the products they are used to manufacture, which counterbalances the difficulty in manufacturing the curved glass.

The above information disclosed in this Background section is only for enhancement of understanding of the background of the invention and therefore it may contain information that does not form the prior art that is already known to a person of ordinary skill in the art.

### SUMMARY

Aspects of embodiments of the present invention are directed toward providing an apparatus and a method for manufacturing a 3D glass having a thin thickness and a small curvature while simplifying the process of manufacturing the 3D glass.

According to an embodiment of the present invention an apparatus for manufacturing 3D glass, includes: a molding part configured to mold a glass substrate; an assembling and disassembling part configured to carry-out the molded glass substrate and replace the glass substrate with an other glass substrate; and a loading part configured to load the molded glass substrate.

The molding part may include: a heating part configured to heat the glass substrate to a molding temperature of the glass substrate; a press part configured to mold the heated glass substrate by pressurization; and a slow cooling part configured to gradually or stepwise cool the molded glass substrate.

The molding part may further include a quenching part, and at least two of the heating part, the slow cooling part, and the quenching part have different temperatures from each other.

The molding part may further include a mold carrying-in part, and the mold carrying-in part may have a temperature of about 350° C. to about 400° C.

The heating part may have a temperature of about 500° C. to about 800° C., and the press part may have a temperature that is the same as that of the heating part.

The quenching part, the slow cooling part, and the press part may have respective temperatures that gradually or stepwise increase in the stated order.

The temperature of the slow cooling part may be lower than that of the heating part and the press part by about 50° C. to about 150° C.

The quenching part may have a temperature of about 350° C. to about 400° C.

The assembling and disassembling part may include a material replacement part configured to carry-out the molded glass substrate and carry-in the other glass substrate into the mold.

The molding part and the assembling and disassembling part may be filled with nitrogen

According to another embodiment of the present invention a method for manufacturing 3D glass includes: carrying-in a mold including a glass substrate into a chamber of a molding part; preheating the carried-in mold; heating the preheated mold; molding the glass substrate by pressing the heated mold; cooling the molded glass substrate; and carrying-out the molded glass substrate and carrying-in an other glass substrate into the mold.

The carrying-in the mold into the chamber of the molding part to the carrying out the mold out of the chamber of the molding part may span a time period of about 20 seconds to about 50 seconds.

The mold may include a plurality of molds and a distance between adjacent molds may be equal to or less than about 180 mm.

In the preheating, the carried-in mold may be preheated at a temperature of about 350° C. to about 400° C.

In the heating, the preheated mold may be heated at a temperature of about 500° C. to about 800° C. and the molding may be carried out at a temperature that is the same as that in the heating.

During the cooling, the molded glass substrate may be cooled at a temperature equal to or less than about 350° C. by gradually or stepwise decreasing from a temperature about 50° C. to about 150° C. lower than that in the heating.

In the molding, a pressure of about 0.2 kN to about 5 kN may be applied to the heated mold.

In the carrying-in the mold into the chamber of the molding part, a temperature of the mold may be about 200° C. to about 350° C.

As set forth above, according to aspects of embodiments of the apparatus and the method for manufacturing 3D glass, it is possible to easily manufacture the 3D glass and shorten the required time of the manufacturing process.

Further, the 3D glass manufactured according to embodiments of the present invention can have excellent physical properties. For example, the 3D glass may have a thickness equal to or smaller than about 1 mm, a curvature equal to or smaller than about 10 mm, and a compressive stress of about 750 MPa to about 950 MPa.

### BRIEF DESCRIPTION OF THE DRAWINGS

The accompanying drawings, together with the specification, illustrate embodiments of the present invention, and, together with the description, serve to explain the principles of the present invention.

FIG. 1 is a block diagram of an apparatus for manufacturing a 3D glass according to an embodiment of the present invention.

FIG. 2 is an exploded perspective view of a mold according to an embodiment of the present invention.

FIG. 3 is another perspective view of the mold of FIG. 2.

### DETAILED DESCRIPTION

The present invention will be described more fully hereinafter with reference to the accompanying drawings, in which exemplary embodiments of the invention are shown, by way of illustration. As those skilled in the art would realize, the described embodiments may be modified in various different ways, all without departing from the spirit or scope of the present invention. Also, in the context of the present application, when a first element is referred to as being “on” a second element, it can be directly on the second element or be indirectly on the second element with one or more intervening elements interposed therebetween. Expressions such as “at least one of,” when preceding a list of elements, modify the entire list of elements and do not modify the individual elements of the list.

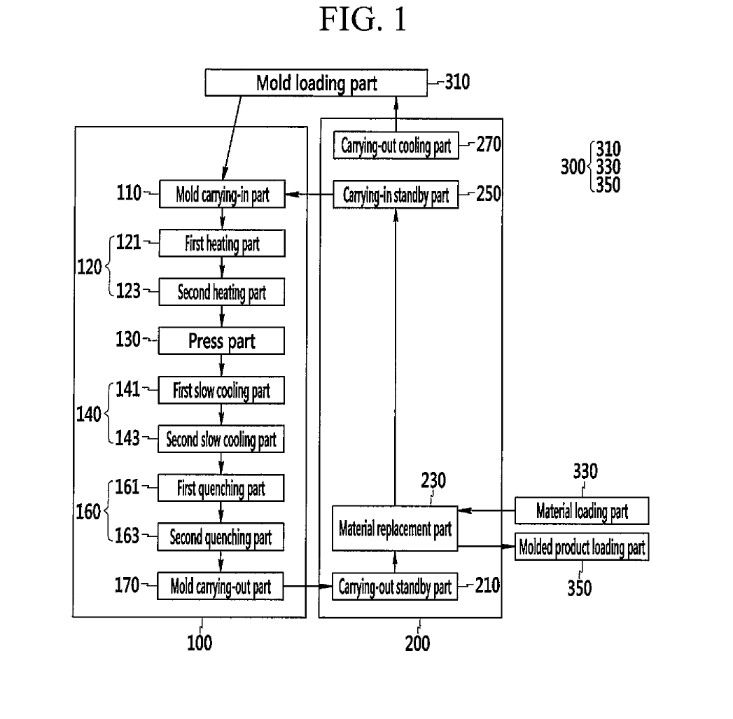

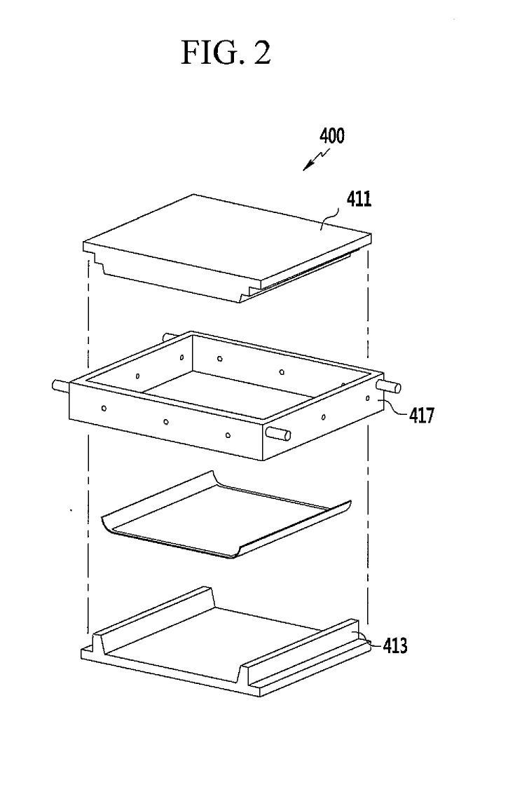

Hereinafter, an apparatus and a method for manufacturing a 3D glass according to an embodiment of the present invention will be described in detail with reference to FIGS. 1 and 2.

As shown in FIG. 1, an apparatus for manufacturing a 3D glass according to an embodiment of the present invention includes a molding part 100, an assembling and disassembling part 200, and a loading part 300.

The molding part 100 manufactures a desired shape, for example, the 3D glass, by carrying-in and out a mold in which a glass substrate is mounted and sequentially delivering the glass substrate to each part included in the molding part 100.

For example, in some embodiments, the molding part 100 includes a mold carrying-in part 110, a heating part 120, a press part 130, a slow cooling part 140, a quenching part 160, and a mold carrying-out part 170.

According to an embodiment of the invention, the mold carrying-in part 110 carries a mold, the mold having an appropriate (or suitable) shape that matches the shape of the glass to be manufactured, into the molding part 100. When the mold is carried into the molding part 100 from the outside, the mold or the glass substrate may be damaged due to a difference in temperature between the inside and the outside of the molding part 100. Therefore, in order to prevent damage or breakage (or reduce the likelihood of damage or breakage) to the mold and the glass substrate, in some embodiments, the mold carrying-in part 110 preheats the mold or the glass substrate. A preheating temperature of the mold carrying-in part may be about 350° C. to about 400° C., for example, about 350° C.

The heating part 120 may be heated to a temperature at which the glass substrate mounted in the mold is molded. For example, a temperature of the heating part 120 may be about 500° C. to about 800° C.

Further, in order to gradually heat the mold and the glass substrate, the molding part 100 may include a plurality of heating parts 120 having different temperatures (e.g., different internal temperatures). According to an embodiment of the present invention, the heating part 120 may include a first heating part 121 and a second heating part 123. In some embodiments, the molding part 100 has a stepped increase in temperature in which a temperature of the second heating part 123 is higher than that of the first heating part 121.

In some embodiments, the press part 130 applies a pressure to the glass substrate, which is heated to the molding temperature, by way of the heating part 120, to mold the glass substrate into an appropriate 3D shape. The press part 130 may maintain a temperature within a range that is the same as or similar to that of the heating part 120 to mold the glass substrate.

For example, the press part 130 may press the glass substrate so as to mold one end of the glass substrate that is located between an upper mold and a lower mold of the mold, such that the pressed end of the glass substrate is deformed into a shape corresponding to a molding surface of the mold by pressurization to mold the end surface of the glass substrate to a shape (e.g., a curved portion). In some embodiments, the press part 130 includes a member which moves up and down to press (or exert pressure on) the mold.

According to an embodiment of the present invention, the mold carrying-in part, the heating part, and the press part may use any heating member to achieve the above-mentioned temperatures and, as an example, the heating member may be a heater or a line of heat.

Further, the pressure applied from the press part 130 to the glass substrate may be about 0.2 kN to about 5 kN.

The press part 130 according to an embodiment of the present invention includes a heater to transfer heat generated from the heater to one end surface of the glass substrate through the upper mold and the lower mold, such that the press part 130 may concurrently (or simultaneously) perform the pressurization and heating of the glass substrate.

When a temperature of the first heating part 121 is higher than that of the mold carrying-in part 110 and a temperature of the second heating part 123 is higher than that of the first heating part 121, the temperature of the glass substrate may gradually increase. For example, the temperature of the glass substrate may gradually increase as the glass substrate moves through molding part 100. In some embodiments, the press part 130 keeps (or maintains) a temperature approximately similar to that of the second heating part 123.

The slow cooling part 140 cools the glass substrate after the glass substrate has been molded in the press part 130. The slow cooling part 140 may be a plurality of slow cooling parts 140 to gradually cool the molded glass substrate without any damage (or with a reduced likelihood of damage). The plurality of slow cooling parts 140 may each have different temperatures. For example, in an embodiment of the present invention, the slow cooling part 140 includes a first slow cooling part 141 and a second slow cooling part 143, and the temperature of the second slow cooling part 143 is lower than that of the first slow cooling part 141.

The temperature of the slow cooling part 140 may be lower, by about 50° C. to about 150° C., than that of the heating part 120 and/or the press part 130, which may prevent the molded glass substrate from being damaged or broken (or may reduce the likelihood of damage or breakage) due to a sudden change in temperature.

In some embodiments, the slow cooling part 140 continuously applies a pressure to the molded glass substrate to prevent (or reduce the likelihood of) shrinkage behavior and/or deformation of the molded glass substrate, thereby maintaining the shape of the molded glass substrate.

The quenching part 160 further cools the molded glass substrate after the molded glass substrate has been cooled by the slow cooling part 140. In some embodiments, the temperature of the quenching part 160 is lower than that of the slow cooling part 140 and is about 350° C. to about 400° C., for example, about 400° C.

The quenching part 160 may be a plurality of quenching parts to gradually cool the glass substrate which is being cooled. The plurality of quenching parts 160 may each have different temperatures. According to an embodiment of the present invention, the quenching part 160 includes a first quenching part 161 and a second quenching part 163 and a temperature of the first quenching part 161 is higher than that of the second quenching part 163.

In some embodiments, the temperatures of the molding part 100 gradually reduce in an order (e.g., a descending order) of the press part 130, the slow cooling part 140, and the quenching part 160, which prevents the molded glass substrate from being broken (or reduces the likelihood of breakage) due to a sudden change in temperature.

After having been cooled by the quenching part 160, the glass substrate and the mold are delivered to the assembling and disassembling part 200 from the molding part 100 by the mold carrying-out part 170.

In embodiments of the present invention, the temperature of the mold as it is being carried-out from the molding part 100, or shortly thereafter, is about 350° C. The mold, which has a large latent heat effect, naturally maintains its heated state. On the other hand, glass substrates do not have the large latent heat effect of the mold and, therefore, when a glass substrate that has been molded on a mold contacts external cold air without having had its temperature gradually reduced, the glass substrate may exhibit a high defective rate, such as deformation and the occurrence of cracks, due to the quenching (or instant quenching) of a surface of the glass substrate. In order to prevent the occurrence of product defects (or to reduce the likelihood of product defects) due to sudden changes in temperature, in some embodiments of the present invention, the temperature of the glass substrate is reduced gradually or stepwise as described above.

Further, the upper mold and the lower mold of the mold delivered from the molding part 100 may have the same (or substantially the same) temperature and pressure conditions. To this end, separate heating apparatuses, cooling apparatuses, and pressing apparatuses may be at each position of the molding part 100 to separately heat, cool, and press the upper mold and the lower mold.

In some embodiments, the respective components described above are divided into separate regions of the molding part 100 and are configured to be heated or cooled to form a stepwise temperature gradient, or to gradually increase and gradually decrease in temperature by having different temperature conditions in each of the divided regions of the molding part 100.

The assembling and disassembling part 200 carries-out the molded glass substrate from the molding part 100 to the outside and provides the molding part 100 with another glass substrate.

In some embodiments, the assembling and disassembling part 200 includes a carrying-out standby part 210, a material replacement part 230, a carrying-in standby part 250, and a carrying-out cooling part 270.

The carrying-out standby part 210 carries-out the mold and the glass substrate from the molding part 100 and keeps the temperature of the mold and the glass substrate at about 300° C. to about 350° C. to prevent the mold and the glass substrate from being broken, damaged, or the like (or to reduce the likelihood of breakage, damage, or the like).

The material replacement part 230 carries-out the molded glass substrate to the outside, for example, by a molded product loading part 350, and mounts a new glass substrate in the mold from which the molded glass substrate was carried-out. Here, the carried-in glass substrate may be carried-in by a material loading part 330 of a loading part 300. The material loading part 330 and the molded product loading part 350 may be connected with the material replacement part 230 to carry-in/out the molded product (e.g., the molded glass substrate) and the new glass substrate at a temperature of about 200° C. to about 350° C. to prevent the molded product and the new glass substrate from being damaged (or to reduce the likelihood of damage) due to a sudden change in temperature.

In some embodiments, the carrying-in standby part 250 waits so as to again carry a mold mounted with a new glass substrate, which is not molded in the material replacement part 230, to the molding part 100.

In the carrying-out cooling part 270, the mold is replaced with another mold or the mold is carried-out when the manufacturing of the glass substrate ends (or is stopped). The carried-out mold may be loaded in the mold loading part 310. When the mold is carried-out from the carrying-out cooling part 270 to the mold loading part 310, the mold is carried-out at a temperature of about 200° C. to about 350° C.

The molding part 100 and the assembling and disassembling part 200 may constantly keep conditions (e.g., may keep substantially constant conditions), such as the above-mentioned temperature and pressure, and may be separately charged with nitrogen so as to prevent (or reduce) damage due to oxidation, and the like.

The loading part 300 includes the mold loading part 310, the material loading part 330, and the molded product loading part 350.

The mold loading part 310 loads a mold carried-out from the assembling and disassembling part 200 and carries the mold into the molding part 100. In order to prevent the mold from being deformed or damaged (or to reduce the likelihood of damage or deformation) during the carrying-in or carrying-out process, the temperature is kept at about 200° C. to about 350° C. For example, in the case of the carrying-in of the mold, the temperature gradually increases from a temperature of about 200° C. to about 350° C. to a higher temperature, and in the case of the carrying-out of the mold, the temperature gradually decreases from a temperature of about 350° C. to about 200° C. to a lower temperature.

The material loading part 330 is connected with the material replacement part 230 of the assembling and disassembling part 200 to carry a material located in the material loading part 330, for example, the glass substrate, to the mold located in the material replacement part 230. To mold the glass substrate without defects (or substantially without defects), the material loading part 330 may further include an inspection part configured to inspect for defects, and the like.

Further, in order to prevent the glass substrate from being deformed or damaged (or to reduce the likelihood of damage or deformation) during the carrying-in of the glass substrate, a temperature of about 200° C. to about 350° C. is kept (or maintained). For example, in the case of the carrying-in of the glass substrate, the temperature of about 200° C. to about 350° C. gradually increases to a higher temperature.

The molded product loading part 350 is connected with the material replacement part 230 of the assembling and disassembling part 200 to be mounted in the mold and carry-out the molded glass substrate. The molded product loading part 350 may further include an inspection part which inspects the defects, and the like, of the molded glass substrate.

Further, in order to prevent the glass substrate from being deformed or damaged (or to reduce the likelihood of damage or deformation) during the carrying-out of the molded glass substrate, that is, the molded product, the temperature is kept (or maintained) at about 200° C. to about 350° C. For example, in the case of the carrying-out of the glass substrate, the temperature of about 350° C. to about 200° C. gradually decreases to a lower temperature.

Hereinafter, a method for manufacturing 3D glass according to an embodiment of the present invention will be described.

The mold including the glass substrate is carried into a chamber of the molding part 100. To prevent the carried-in glass substrate and mold from being damaged (or to reduce the likelihood of damage), in the carrying-in the glass substrate and mold into the chamber of the molding part, the temperature is about 200° C. to about 350° C., and, in some embodiments, the temperature may be gradually increased within or above the temperature range from about 200° C. to about 350° C.

Next, the carried-in mold and glass substrate are preheated. During preheating, the mold and glass substrate are preheated at a temperature of about 350° C. to about 400° C. The preheating may be divided into a plurality of stages to perform gradual preheating. For example, the first preheating may be performed at a temperature of about 350° C. and then the second preheating may be performed at a temperature of about 400° C. The preheating temperature is not limited to the foregoing temperatures. For example, the preheating may be performed at a range of gradually increasing temperatures.

Next, the preheated mold is heated to a temperature which can mold the glass substrate. In the heating, the mold is heated at a temperature of about 500° C. to about 800° C. The heating may be divided into a plurality of stages to perform gradual heating. For example, the first heating may be performed at a temperature of about 550° C. and then the second heating may be performed at a temperature of about 750° C. The heating temperature is not limited to the foregoing temperatures. For example, the heating may be performed at any suitable temperature, and a range of gradually increasing temperatures may be used as the heating temperature.

Next, the glass substrate is molded by pressing the heated mold and glass substrate. The temperature in the molding of the glass substrate may be the same as or similar to the temperature in the heating.

Further, in the molding, the pressure is about 0.2 kN to about 5 kN (e.g., a pressure of about 0.2 kN to about 5 kN is applied to the mold) to form a molded glass substrate.

Next, the molded glass substrate is cooled. In order to prevent the molded glass substrate from being damaged (or to reduce the likelihood of damage) due to a sudden change in temperature, the temperature of the cooling may gradually decrease from the temperature of the heating to a temperature lower than that of the heating by about 50° C. to about 150° C. In some embodiments, the cooling may be divided into a plurality of stages to gradually cool the glass substrate.

In embodiments of the present invention, the cooling may include slow cooling and quenching and the slow cooling and the quenching may each be divided into a plurality of stages. In the plurality of slow cooling stages and the plurality of quenching stages, the molded glass substrate is cooled at a gradually or stepwise decreasing temperature and is finally cooled at a temperature of about 400° C.

Next, the mold and molded glass substrate are carried-out from the chamber of the molding part. The mold and the molded glass substrate are carried-out to the molded product loading part and the mold is again mounted with a new glass substrate (e.g., an other glass substrate). The mold in which the new glass substrate is mounted is carried back into the chamber of the molding part.

To prevent the mold, the glass substrate, and the molded product (e.g., the molded glass substrate) from being damaged and broken (or to reduce the likelihood of damage or breakage) during the carrying-in and carrying-out, the carrying-in and the carrying-out are performed at a temperature of about 200° C. to about 350° C., and, in some embodiments, the temperature gradually decreases or increases within the foregoing temperature range.

The glass substrate is delivered (or circulated) among the molding part 100, the assembling and disassembling part 200, and the loading part 300 (or within the configuration of the apparatus) by a delivery apparatus.

As the delivery apparatus according to the embodiment of the present invention, any suitable device or mechanism for delivering (or circulating) the mold and the glass substrate mounted therein may be used. For example, a circulating conveyor, such as a circular conveyor, an oval conveyor, and/or a tubular conveyor may be used.

In embodiments of the above-described method, an amount of time elapsed (or consumed) in carrying-in the mold carried into the chamber of the molding part to the carrying-out the mold out of the chamber of the molding part is about 20 seconds to about 50 seconds, for example, about 45 seconds.

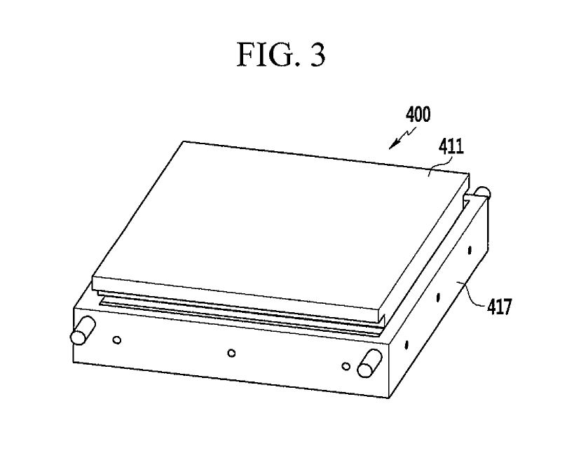

FIG. 2 is an exploded perspective view of a mold 400 according to an embodiment of the present invention and FIG. 3 is another perspective view of the mold 400. An apparatus for manufacturing 3D glass according to embodiments of the present invention may use various molds, but as an example according to an embodiment of the present invention, the mold 400 as illustrated in FIG. 2 may be used.

The mold 400 includes a lower mold 413 having the glass substrate on an upper surface thereof in a preheated state, and an upper mold 411 on the glass substrate, and a guide housing 417 fixing the glass substrate at the time of delivering the glass substrate.

Further, the upper mold 411 and the lower mold 413 face each other and when the upper mold 411 and the lower mold 413 reach the press part by the delivery apparatus, the glass substrate is faced with the curved molding surface of the mold through the movement of the upper mold 411 and the lower mold 413.

The material of the upper mold 411 and the material of the lower mold 413 are not limited, but according to embodiments of the present invention, may be glass, carbon, graphite, glassy carbon (which is a material having excellent release ability), hard metal (e.g., W/C, or tungsten carbide), hard metal coated with diamond like carbon (DLC), Pt—Ir (which are noble metals), and the like. To improve durability, the material of the upper mold 411 and the material of the lower mold 413 may further include nitrides, such as TiN, TiAlN, and BN (which have excellent heat resistance), but the material of the upper mold 411 and the material of the lower mold 413 are not limited thereto.

According to an embodiment of the present invention, a plurality of molds 400 may be seated on an upper surface of a conveyor at a predetermined (or preset) interval and may be circulated along the conveyor. In some embodiments, a distance between adjacent molds of the plurality of molds is equal to or less than about 180 mm.

Further, the glass substrate according to embodiments of the present invention may be made of any material suitable for manufacturing the 3D glass. For example, the glass substrate may be Soda-lime glass or alumina based glass. Using the apparatus and/or the method for manufacturing 3D glass described herein, the glass substrate may be used to make 3D glass having excellent physical properties, such as a thickness of about 1 mm or less, a curvature of about 10 mm or less, and a compressive stress of about 750 MPa to about 950 MPa.

The molded product (e.g., the molded glass substrate) manufactured as described above, may further be treated using a fine polishing process, a hot air drying process, and/or a chemical strengthening and coating process.

For example, the molded glass substrate may have a 3D shape and may be further treated using a fine polishing process. For example, the inside and the outside of the molded glass substrate may be polished by a general polishing method using a polishing material including cerium oxide and a brush type pad.

Next, a cleaner and ultrasonic waves, which may be used in a general cleaning process, of glass are used to clean the molded glass substrate and a drying process (e.g., a drying process using hot air) may be performed.

Next, a strengthening process may be performed. For example, as a general method, the strengthening process may use a salt bath, such as potassium nitride, to preheat the molded glass substrate in a potassium nitride solution and perform the heating. Thereafter, some or all Na⁺ ions of the molded glass substrate are substituted with K⁺ ions.

After the chemical strengthening, the cleaning process may be performed on the molded glass substrate again and then a printing process may be performed on the molded glass substrate. The printing may be a film lamination method, an inkjet method, and the like, but is not limited thereto and any suitable method for printing a 3D shape may be performed.

After the printing process, the coating processing may be performed on a surface of the molded glass substrate to reduce the amount of foreign particles present and reduce the reflectivity of the molded glass substrate. Any suitable coating processing method may be performed. The reflectivity may be reduced by coating a thin film (e.g., a plurality of layers) on the molded glass substrate and the foreign particles may be easily removed, for example, a finger print may be removed from a surface of the molded glass substrate, by coating a material having a low surface energy on the molded glass substrate.

Temperatures and pressures used in methods according to embodiments of the present invention are shown in Tables 1 to 3.

TABLE 1

| | | Preheating | Robotic Hand | Molding | |
|---|---|---|---|---|---|
| | | Temperature | Temperature | Temperature | |
| | Sample | (° C.) | (° C.) | (° C.) | Results |
| 1 | Glass | 200 | 300 | 400 | Good |
| | substrate | | | | |
| 2 | Glass | 150 | 275 | 400 | Good |
| | substrate | | | | |
| 3 | Glass | 100 | 250 | 400 | Good |
| | substrate | | | | |
| 4 | Glass | 50 | 200 | 400 | Broken |
| | substrate | | | | |

TABLE 2

| | | Preheating | Robotic Hand | Molding | |
|---|---|---|---|---|---|
| | | Temperature | Temperature | Temperature | |
| | Sample | (° C.) | (° C.) | (° C.) | Results |
| 1 | Molded | 200 | 300 | 400 | Good |
| | product | | | | |
| 2 | Molded | 150 | 275 | 400 | Good |
| | product | | | | |
| 3 | Molded | 100 | 250 | 400 | Good |
| | product | | | | |
| 4 | Molded | 50 | 200 | 400 | Broken |
| | product | | | | |

As can be seen in Tables 1 and 2, examples of temperatures suitable for delivering the glass substrate which is not molded and the molded glass substrate were tested.

For example, as can be seen in Tables 1 and 2, breakage may occur when a first temperature is about 50° C. and a temperature at the time of delivering the glass substrate is about 200° C. In the fourth sample and in the fourth Experimental Example shown in Tables 1 and 2, respectively, it was confirmed that the glass was broken.

TABLE 3

| | | | | | Second slow | First | Second | |
|---|---|---|---|---|---|---|---|---|
| | First heating | Second | Press part | First slow cooling | cooling part | quenching | quenching | |
| | part | heating part | temperature | part temperature | temperature | part | part | |
| | temperature | temperature | (° C.) and | (° C.) and | (° C.) | temperature | temperature | Shape |
| | (° C.) | (° C.) | pressure | pressure | and pressure | (° C.) | (° C.) | degree |
| Comparative | 600 | 800 | 800 | 700 | 600 | 500 | 400 | Non-molding |
| Example 1 | | | 1 kN | 1 kN | 0 kN | | | |
| Comparative | 650 | 830 | 800 | 700 | 600 | 500 | 400 | Non-molding |
| Example 2 | | | 1 kN | 1 kN | 3 kN | | | |
| Comparative | 650 | 800 | 800 | 700 | 800 | 500 | 400 | Occurrence |
| Example 3 | | | 3 kN | 3 kN | 3 kN | | | of stabbing |
| Comparative | 650 | 800 | 800 | 700 | 600 | 500 | 400 | Occurrence |
| Example 4 | | | 6 kN | 6 kN | 3 kN | | | of stabbing |
| Comparative | 650 | 800 | 800 | 700 | 600 | 500 | 400 | Occurrence |
| Example 5 | | | 6 kN | 6 kN | 3 kN | | | of breakage |
| Comparative | 600 | 800 | 800 | 700 | 600 | 500 | 400 | Occurrence |
| Example 6 | | | 6 kN | 6 kN | 3 kN | | | of stabbing |
| Comparative | 600 | 800 | 800 | 700 | 600 | 500 | 400 | Occurrence |
| Example 7 | | | 10 kN | 10 kN | 3 kN | | | of stabbing |
| Comparative | 600 | 900 | 900 | 700 | 600 | 500 | 400 | Melting of |
| Example 8 | | | 10 kN | 10 kN | 10 kN | | | substrate |
| | | | | | | | | portion |
| Comparative | 600 | 900 | 900 | 700 | 600 | 500 | 400 | Melting of |
| Example 9 | | | 10 kN | 10 kN | 10 kN | | | substrate |
| | | | | | | | | portion |
| Comparative | 550 | 830 | 830 | 700 | 600 | 500 | 400 | Melting of |
| Example 10 | | | 1 kN | 5 kN | 5 kN | | | substrate |
| | | | | | | | | portion |
| Comparative | 550 | 860 | 860 | 700 | 600 | 500 | 400 | Melting of |
| Example 11 | | | 1 kN | 5 kN | 5 kN | | | substrate |
| | | | | | | | | portion |
| Comparative | 550 | 750 | 800 | 700 | 600 | 500 | 400 | Occurrence |
| Example 12 | | | 3 kN | 5 kN | 5 kN | | | of stabbing |
| Comparative | 550 | 750 | 800 | 700 | 600 | 500 | 400 | Occurrence |
| Example 13 | | | 3 kN | 10 kN | 10 kN | | | of stabbing |
| Comparative | 550 | 750 | 800 | 700 | 600 | 500 | 400 | Occurrence |
| Example 14 | | | 1 kN | 1 kN | 1 kN | | | of stabbing |
| Example 1 | 550 | 780 | 780 | 700 | 600 | 500 | 400 | Moldable |
| | | | 1 kN | 5 kN | 5 kN | | | |
| Example 2 | 550 | 760 | 760 | 700 | 600 | 500 | 400 | Moldable |
| | | | 3 kN | 3 kN | 1 kN | | | |
| Example 3 | 550 | 750 | 750 | 700 | 600 | 500 | 400 | Moldable |
| | | | 3 kN | 3 kN | 1 kN | | | |
| Example 4 | 550 | 770 | 770 | 700 | 600 | 500 | 400 | Moldable |
| | | | 3 kN | 3 kN | 2 kN | | | |
| Example 5 | 550 | 755 | 755 | 700 | 600 | 500 | 400 | Moldable |
| | | | 3 kN | 3 kN | 2 kN | | | |
| Example 6 | 550 | 775 | 775 | 700 | 600 | 500 | 400 | Moldable |
| | | | 3 kN | 3 kN | 1 kN | | | |

Further, for the moldable glass substrate, it can be appreciated from Table 3 that as the manufacturing process conditions, the temperature of the heating part may be about 500° C. to about 800° C. and may be kept to be the same as or similar to the temperature of the second heating part in the press part, and then the temperature may be gradually decreased to about 400° C. in the quenching part.

Further, it can be appreciated that the range of the pressure applied in the press part and the slow cooling part may be a maximum of about 5 kN.

Therefore, when the glass substrate is molded, depending on the process conditions as described above, a thin 3D glass having excellent physical properties, such as a small curvature, may be manufactured by the simple process disclosed herein.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims, and equivalents thereof.

### Description of Symbols

100: Molding part
110: Mold carrying-in part
120: Heating part
121: First heating part
123: Second heating part
130: Press part
140: Slow cooling part
141: First slow cooling part
143: Second slow cooling part
160: Quenching part
161: First quenching part
163: Second quenching part
170: Mold carrying-out part
200: Assembling and disassembling part
210: Carrying-out standby part
230: Material replacement part
250: Carrying-in standby part
270: Carrying-out standby part
300: Loading part
310: Mold loading part
330: Material loading part
350: Molded product loading part
400: Mold
411: Upper mold
413: Lower mold
417: Guide housing

What is claimed is:

1. An apparatus for manufacturing 3D glass, the apparatus comprising:
a molding part configured to mold a glass substrate;
an assembling and disassembling part configured to carry-out the molded glass substrate and replace the molded glass substrate with an other glass substrate; and
a loading part configured to load the molded glass substrate.

2. The apparatus of claim 1, wherein:
the molding part comprises:
a heating part configured to heat the glass substrate to a molding temperature of the glass substrate;
a press part configured to mold the heated glass substrate by pressurization; and
a slow cooling part configured to gradually or stepwise cool the molded glass substrate.

3. The apparatus of claim 2, wherein:
the molding part further comprises a quenching part, and
at least two of the heating part, the slow cooling part, and the quenching part have different temperatures from each other.

4. The apparatus of claim 3, wherein:
the molding part further comprises a mold carrying-in part, and the mold carrying-in part has a temperature of about 350° C. to about 400° C.

5. The apparatus of claim 4, wherein:
the heating part has a temperature of about 500° C. to about 800° C., and the press part has a temperature that is the same as that of the heating part.

6. The apparatus of claim 5, wherein:
the quenching part, the slow cooling part, and the press part have respective temperatures that gradually or stepwise increase in the stated order.

7. The apparatus of claim 6, wherein:
the temperature of the slow cooling part is lower than that of the heating part and the press part by about 50° C. to about 150° C.

8. The apparatus of claim 3, wherein:
the quenching part is has a temperature of about 350° C. to about 400° C.

9. The apparatus of claim 1, wherein:
the assembling and disassembling part comprises a material replacement part configured to carry-out the molded glass substrate and carry the other glass substrate into the mold.

10. The apparatus of claim 1, wherein:
the molding part and the assembling and disassembling part are filled with nitrogen.

11. A method for manufacturing 3D glass, comprising:
carrying-in a mold comprising a glass substrate into a chamber of a molding part;
preheating the carried-in mold;
heating the preheated mold;
molding the glass substrate by pressing the heated mold;
cooling the molded glass substrate; and
carrying-out the molded glass substrate and carrying-in an other glass substrate into the mold.

12. The method of claim 11, wherein:
the carrying-in of the mold into the chamber of the molding part to the carrying-out the mold out of the chamber of the molding part spans a time period of about 20 seconds to about 50 seconds.

13. The method of claim 11, wherein:
the mold comprises a plurality of molds and a distance between adjacent molds is equal to or less than about 180 mm.

14. The method of claim 11, wherein:
in the preheating, the carried-in mold is preheated at a temperature of about 350° C. to about 400° C.

15. The method of claim 11, wherein:
in the heating, the preheated mold is heated at a temperature of about 500° C. to about 800° C. and the molding is carried out at a temperature that is the same as that in the heating.

16. The method of claim 11, wherein:
in the cooling, the molded glass substrate is cooled at a temperature equal to or less than about 350° C. by gradually or stepwise decreasing from a temperature about 50° C. to about 150° C. lower than that in the heating step.

17. The method of claim 11, wherein:
in the molding, a pressure of about 0.2 kN to about 5 kN is applied to the heated mold.

18. The method of claim 11, wherein:
in the carrying-in the mold into the chamber of the molding part, a temperature of the mold is about 200° C. to about 350° C.
